(19) United States
(12) Patent Application Publication
(10) Pub. No.: US 2010/0078418 A1
(43) Pub. Date: Apr. 1, 2010

(54) METHOD OF LASER MICRO-MACHINING STAINLESS STEEL WITH HIGH COSMETIC QUALITY

(75) Inventors: Weisheng Lei, San Jose, CA (US); Mehmet E. Alpay, Portland, OR (US); Hisashi Matsumoto, Hillsboro, OR (US); Jeffrey Howerton, Portland, OR (US); Guangyu Li, Portland, OR (US); Peter Pirogovsky, Portland, OR (US); Wilson Lu, Portland, OR (US); Glenn Simenson, Portland, OR (US)

Correspondence Address: Electro Scientific Industries Inc.;c/o Young Basile Hanlon & MacFarlane, P.C., 3001 West Big Beaver Rd., Ste. 624, Troy, MI, 48084, US

(73) Assignee: ELECTRO SCIENTIFIC INDUSTRIES, INC., Portland, OR (US)

(21) Appl. No.: 12/413,272

(22) Filed: Mar. 27, 2009

Related U.S. Application Data
(63) Continuation-in-part of application No. 12/238,995, filed on Sep. 26, 2008.

(51) Int. Cl. B23K 26/38

(52) U.S. Cl. 219/121.72

(57) ABSTRACT

A process to laser micro-machine a metal part with a high cosmetic quality surface includes applying a protective coating layer to at least one surface of the part before micro-machining the part with a laser. The protective coating applied to the high quality cosmetic surface can have a thickness of between about 5 mil and about 10 mil, inclusive and have sufficient adhesion strength to adhere to the part without delaminating during processing. The protective coating applied to the machining surface of the part can be a metallic material, such as a metallic foil or tape.

### CROSS-REFERENCE TO RELATED APPLICATION

This application is a continuation-in-part of U.S. patent application Ser. No. 12/238,995, filed Sep. 26, 2008.

### FIELD OF THE INVENTION

This invention provides a low-cost efficient way to maintain high cosmetic finish quality in laser micro-machining of consumer products made of stainless steels.

### BACKGROUND

For most consumer products, stainless steels are demanded to bear durable cosmetic finishes that are also endowed with superior performance characteristics including high levels of scratch resistance, easy-to-clean properties, resistance to discoloration, etc. Mechanical approaches have been used to make features such as apertures and slots without big concern on damaging the cosmetic finishes. As feature size gets smaller and smaller, laser micro-machining technologies are called in. When laser micro-machining technologies are applied to generate fine features on stainless steels bearing durable cosmetic finishes, due to the nature of thermal process for laser metal interaction, the cosmetic finishes can be easily damaged due to discoloration and delaminated due to oxidization and thermal stresses. Until today, laser micro-machining is still a relatively new technology as applied to stainless steels with an emphasis on cosmetic performance and little is published in this area.

### SUMMARY

Embodiments of the invention provide methods or processes to laser micro-machine a metal part with a high cosmetic finish quality surface and an opposing surface. One embodiment includes applying a protective coating layer to the high cosmetic finish quality surface and/or the opposing machining surface before micro-machining the part with a laser.

In another embodiment of a process to laser micro-machine a stainless steel part with a high cosmetic quality surface and an opposing surface, the improvement includes applying a protective coating layer to one of the surfaces to be machined before micro-machining the part with a laser and micro-machining that surface with the laser. The laser is a nano-second pulse width laser or a micro-second pulse width laser. The protective coating layer comprises a metallic material including at least one of aluminum, copper and stainless steel.

Variations and details respecting these and other applications of the present invention will become apparent to those skilled in the art when the following description is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic view of a stainless steel part having a high quality cosmetic surface and a laser for micromachining the part;

FIG. 2 is a simplified schematic view of a stainless steel part having a high quality cosmetic surface, a protective layer on at least one surface of the part and a laser for micro-machining the part;

FIG. 3 is a simplified process flow diagram illustrating an embodiment of the invention;

FIG. 4 is a magnified image of a post-process part surface of a 500 um-thick stainless steel part drilled with through holes having a diameter of 350 μm in the absence of a protective layer taught herein; and

FIG. 5 is a magnified image of a post-process part surface of a 500 um-thick stainless steel part drilled with through holes having a diameter of 350 μm using a protective layer taught herein.

### DETAILED DESCRIPTION

One challenge when using lasers to micro-machine stainless steels with cosmetic finishes is the discoloration surrounding the features generated, which makes the appearance of the consumer products unacceptable. Discoloration is believed to be due to the oxidization during the laser micro-machining process, which heats up the metal surfaces sufficiently to significantly enhance oxidization or nitridization of the metal surface with oxygen and nitrogen coming from the air. Although one can put the parts to be machined in vacuum or in a chamber filled with inert gases to isolate the parts from oxygen or nitrogen, or use a laser of extremely short pulse width, such as a ps- or fs-laser source, to significantly confine the thermal process, the cost can be very high. These solutions can also make the process very inconvenient.

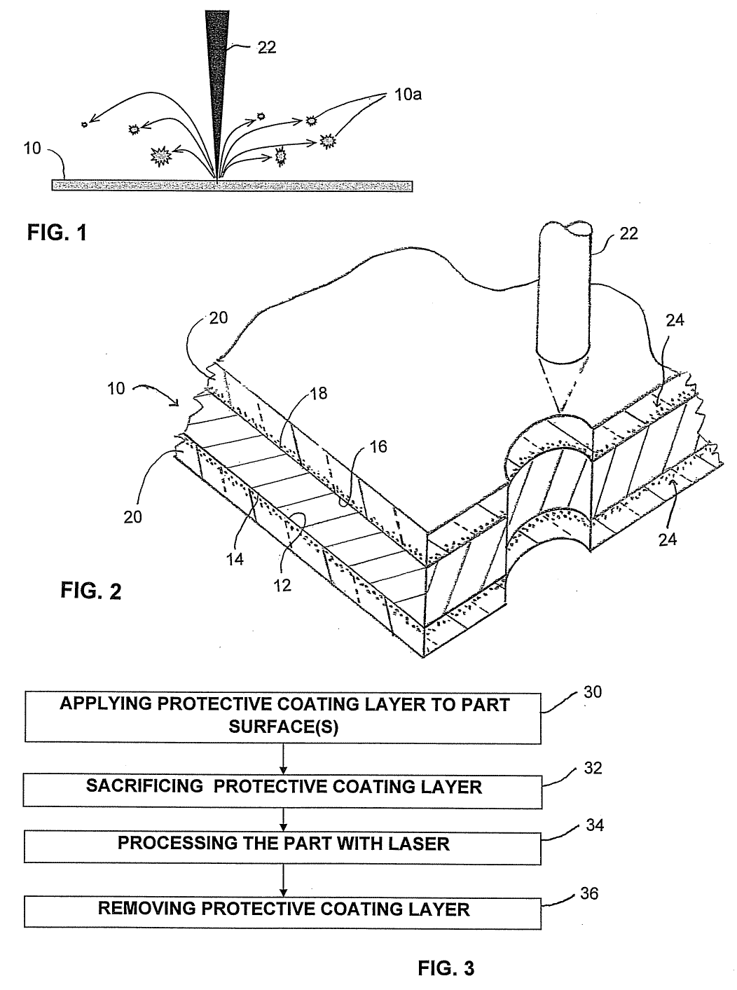

Another challenge is debris splash. That is, as shown in FIG. 1, when the metal substrate or part 10, in this case stainless steel, is laser machined by a high power laser 22, a substantial amount of molten material 10a is ejected from the process area and gets deposited in the immediate vicinity of a substrate surface 16. Molten material 10a is debris splash and comprises small particles moving at very high speeds and/or are at or beyond the melting temperature of part 10. The presence of this debris splash can also make the appearance of a resulting consumer product unacceptable as the cosmetic qualities of the process surface generally need to be maintained. Short pulse width lasers, where the material removal process is more through sublimation and less through melting, can also be used to address this problem. The vacuum mentioned above, or an assist gas, can also be used to keep debris from falling back on the process area. As mentioned, these solutions increase cost and reduce convenience. Post-process cleaning of the part to remove the debris that remains stuck on the surface is an option. However, this again increases cost and reduces convenience, and it does not address the issue of discoloration.

One embodiment of the invention proposes to apply a protective coating layer on a cosmetic side of the metal part to physically isolate the part from the air during a laser micro-machining process. The protective coating layer can also be applied to the opposing side of the part to reduce debris and discoloration. In the case where an organic protective coating layer is applied, it also serves as a sacrificing layer to block/consume oxygen in air by carbonization and oxidization due to strong laser irradiation, even though the protective coating layer is relatively transparent to the laser beam under low intensity.

The protective coating layer can be an organic material such as adhesive polymers, or inorganic materials such as ceramic. The protective coating layer can be applied either in rigid form (by way of example and not limitation, such as a dry-film adhesive tape), or in liquid form (by way of example and not limitation, such as an adhesive, a wax, or thick resists). The protective coating layer can be applied via spin coating, or spraying, depending on the geometry of the part. Scotch tapes are a good example of a suitable protective coating layer. Transparent blue tape is used in the semiconductor industry to hold wafers, and is another good example of a suitable protective coating layer. In one embodiment, the coating layer should be highly transparent to the applied laser beam, provide sufficient adhesion strength with respect to the part, and have a thickness between approximately 5 mils and approximately 10 mils, inclusive. The process according to an embodiment of the present invention significantly relieves the requirements of a laser, such that a regular nano-second pulse width laser, or micro-second pulse width laser, will meet the requirements for the purpose of micro-machining metal parts with high quality cosmetic surface finishes. The process has been used to drill and cut stainless steel parts with cosmetic finishes in the lab and has proven to be successful. The process provides an easy, low cost, approach that does not demand an expensive short pulse width laser.

Referring to FIG. 2, a simplified schematic view of metal part 10, by way of example and not limitation, such as a stainless steel part, is shown having a high quality cosmetic surface 12 on a first or front side 14 and another surface 16 on a second, rear or back side 18. A protective coating layer 20 is located on at least one surface 12, 16 of part 10. A laser 22 is used to micro-machine part 10 with protective coating layer 20. Although laser 22 is shown as drilling second surface 16, laser 22 drills first surface 12 in some embodiments. Protective coating layer 20 can be applied to high cosmetic finish quality surface 12 of part 10 to physically isolate surface 12 from air prior to micro-machining part 10 with laser 22.

Protective coating layer 20 can be relatively transparent to a laser beam under low intensity from laser 22. Protective coating layer can be an organic material, or inorganic material, serving as a sacrificing layer to block/consume oxygen in air by carbonization and oxidation due to strong laser irradiation. By way of example and not limitation, an organic material protective coating layer 20 is an adhesive polymer. By way of example and not limitation, an inorganic material protective coating layer 20 is a ceramic material.

Protective coating layer 20 can be applied to part 10 in a variety of ways depending on the processing costs for a particular part geometry. By way of example and not limitation, the protective coating layer 20 is applied in a rigid dry form, such as a dry film adhesive tape, or can be applied in a liquid form. The dry film adhesive tape protective coating layer 20 can be selected from a group consisting of a clear adhesive tape, a transparent blue adhesive tape, and any combination thereof. By way of example and not limitation, a liquid form protective coating layer 20 is selected from a group consisting of an adhesive, a wax, a thick resist, and any combination thereof. Protective coating layer 20 can be applied via an application process selected from a group consisting of spin coating, spraying, and any combination thereof. Protective coating layer 20 is highly transparent to an applied laser beam from laser 22. Protective coating layer 20 has, for example, a thickness of between approximately 5 mils and approximately 10 mils, inclusive. Protective coating layer 20 can have inherent adhesive properties, or an additional adhesive interface 24 can be used with sufficient adhesion strength to adhere to part 10 without delaminating during processing. Protective coating layer 20 can be applied to either surface 12, 16 to reduce debris and/or discoloration. The laser 22 for micro-machining the part 10 can be selected from a group consisting of a nano-second pulse width laser and a micro-second pulse width laser.

Referring now to FIG. 3, a simplified process diagram is illustrated. A process according to one embodiment of the present invention can include one or more of the process steps illustrated. By way of example and not limitation, the process includes at step 30 applying a protective coating layer 20 to at least one surface 12, 16 of a stainless steel part 10 to physically isolate the surface 12, 16 from air prior to micro-machining the part 10 with a laser 22. Protective coating layer 20 can be sacrificed to block and/or consume oxygen in the air by carbonizing and/or oxidation due to strong laser irradiation as shown in step 32. At step 34, part 10 is processed with a laser 22, such as one selected from a group consisting of a nano-second pulse width laser and a micro-second pulse width laser. According to certain embodiments, it is desirable to include a conventional inert gas assist during this laser processing. Any remaining portions of protective coating layer 20 can then be removed at step 36 according to known methods depending on its material and the material of part 10.

When using a nano-second laser as laser 22, drilling of part 10 can occur in either surface, that is, cosmetic surface 12 or its opposing, back surface 16. The description above provides that protective coating layer 20 can be applied to one or both surfaces 12, 16 of part 10, including the one of surfaces 12, 16 that receives the laser irradiation from laser 22. It is most desirable, however, to apply protective coating layer 20 to the drilling surface, whether the drilling surface is the cosmetic surface 12 or the back surface 16. Accordingly, the material of protective coating layer 20 was chosen to be essentially transparent to the laser beam for this purpose. Examples include an adhesive polymer, some kind of transparent tape, etc. Incorporating such a protective coating layer 20 and using an inert assist gas, the above-described discoloration problem was reduced. However, use of these materials for protective coating 20 on surface 16, which was the drilled surface in testing, did not sufficiently protect the surface from molten particles 10a. These particles 10a resulted in melting of the thin protective coating layer 20. A thicker protective layer 20 for the surface 16 is one possible solution.

Another solution is to use instead a different material for protective coating layer 20, here a metallic material. In contrast to the previous approach described, the metallic material is not transparent to the laser beam. As such, instead of passing through protective coating layer 20, laser 22 must actually cut through protective coating layer 20 when metallic protective coating layer 20 is applied to the drilling surface. Therefore, the metallic material of protective coating layer 20 should be thin enough that having to go through it to reach part 10 for processing does not substantially add to the overall process time. Further, the metallic material should couple well enough with laser 22 such that laser 22 can machine through protective coating layer 20 and reach part 10 underneath. Finally, the material is thick enough and/or has a high enough melting point to withstand the debris splash. That is, the material does not let the super-hot particles 10a comprising the debris splash to burn their way through and embed themselves on part 10 that is underneath protective coating layer 20.

The material can be a metal foil or tape, for example, a copper foil, an aluminum foil, a thin sheet of stainless steel, or the like. Metallic protective coating layer 20 can be made thin enough for machining and have high melting points to withstand particles 10a. For example, the melting point of Aluminum is 660° C., the melting point of Copper is 1084° C., and the melting point of Steel is 1370°. Protective coating layer 20 is most desirably applied on the drilling surface, whether it is high quality cosmetic surface 12 or back surface 16. Alternatively, no protective coating layer 20 can be included on one of the surfaces 12, 16, or both surfaces 12, 16 can be covered with the metallic material as protective coating layer 20.

When using a nano-second laser as laser 11, drilling of part 10 including metallic protective coating layer 20 can occur on either surface 12, 16 as described with respect to the polymer-type protective coating layer 20. When using a micro-second laser, it is preferred, but not necessary, that metallic protective coating layer 20 be used on the drilling surface as opposed to polymer-type protective coating layer 20 and that the drilling surface is the cosmetic surface 12.

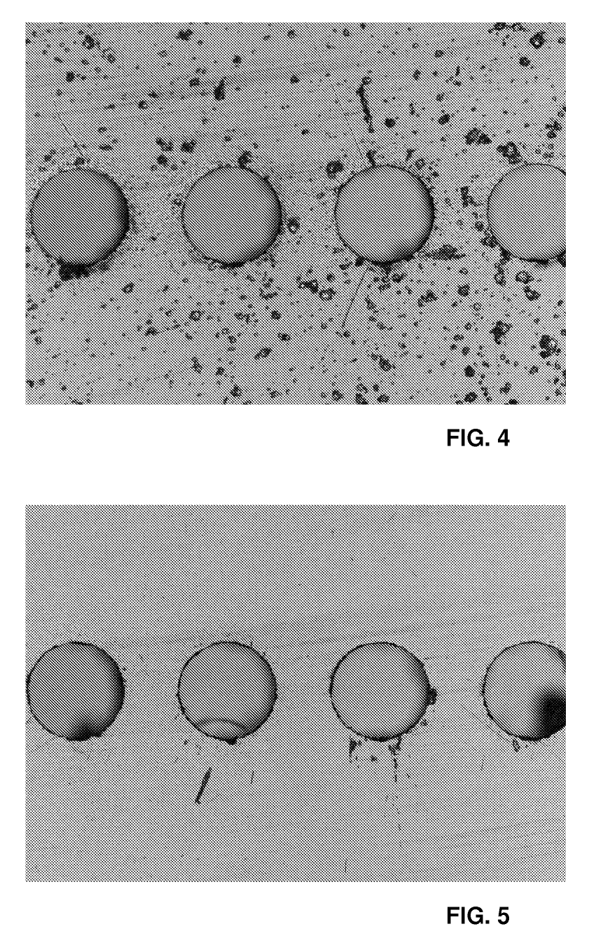

In one implementation, an IPG 700 W IR laser with coaxial Nitrogen gas assist was used to drill holes on a 500 um-thick stainless steel part. The stainless steel was pre-finished such that the surface was of high cosmetic quality, i.e., it had a highly polished surface. FIG. 4 shows surface damage due to debris splash without using a protective coating layer taught herein. In contrast, when performing the same processing using a protective coating layer, the surface damage was significantly reduced as shown in FIG. 5. That is, both discoloration and debris splash was minimized. The protective coating layer used with the application of FIG. 5 was a 50 μm thick Aluminum foil stretched taut against the drill surface. This test demonstrated that the very same holes can be drilled using the same process parameters both with and without the protective coating layer. Accordingly, the metallic material couples well enough with the process laser to machine through the protective coating layer without substantially adding to overall process time. Further, the use of the protective coating layer was able to virtually eliminate debris splash from the part surface.

Since the part was stainless steel in this test, super-hot particles comprising the debris splash were at least 1370° C. Yet, the Aluminum foil having a melting point of only 660° C. was able to “stop” these particles. Without being bound by theory, it is believed that, although the debris splash is hot, the particles comprising it are fairly small. They are smaller than 500 μm in diameter and could be much smaller. Accordingly, they quickly lose their heat as they hit the protective coating layer 20 and start burrowing through it. As long as the particles get “stuck” inside the protective layer and not make it through to the part surface, the metallic material is said to be thick enough and has a high enough melting point. Again, too thick a layer of metallic material would also be undesirable as it would add substantially to the drilling/cutting effort. Tests with 0.001″ Copper tape and a 0.001″ stainless steel foil also showed a desirable reduction in discoloration and debris splash.

In comparison with other ways of improving surface appearance, embodiments of the present invention provide significant benefits. For example, use of a short pulse-width to eliminate or substantially reduce debris splash is not always feasible for two main reasons. First, such lasers do not typically have the power levels required for fast processing of metal parts, and second, they tend to be substantially more expensive than their long pulse-width counterparts. Another possibility is the use of air/gas jets and/or a vacuum to prevent debris from falling back on the part surface. This is not at all practical in those cases where the particles comprising the debris splash have high momentum, which makes it almost impossible to substantially alter their trajectories with air/gas flow alone. Finally, post-process cleaning of the part is undesirable in many cases as it adds an extra step to part production, reducing overall throughput. This approach might also be unfeasible where the part in question has a highly-polished surface, which eliminates the possibility of hard “scrubbing” and tends to accentuate event the most minor surface imperfections. Embodiments of the present invention are relatively cheaper, simpler and more effective. High quality cuts are made while protecting the cosmetic surface of the part.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. In a process to laser micro-machine a metal part with a high cosmetic finish quality surface and an opposing surface, the improvement comprising:
applying a protective coating layer to at least one of the high cosmetic finish quality surface and the opposing surface before micro-machining the part with a laser.

2. The process of claim 1 wherein the protective coating layer is applied to a one of the high cosmetic finish quality surface and the opposing surface to be machined, the protective coating layer being sufficiently thin such that a processing time for machining the metal part with the protective coating layer is about equal to a processing time for machining the metal part without the protective coating layer, the protective coating layer being at least one of sufficiently thick to prevent debris splash from burning through the protective coating layer to embed on the opposing machining surface and made of a material with a high enough melting point to prevent the debris splash from burning through the protective coating layer to embed on the opposing machining surface

3. The process of claim 2 wherein the material of the protective coating layer is a metallic material.

4. The process of claim 1 wherein the protective coating layer is at least one of a copper foil, an aluminum foil and a sheet of stainless steel.

5. The process of claim 1 wherein the metal part comprises a stainless steel.

6. The process of claim 1 wherein the protective coating layer is applied to the high cosmetic finish quality surface and comprises one of an organic material and an inorganic material serving as a sacrificing layer to block/consume oxygen in air from the high cosmetic finish quality surface during laser irradiation.

7. The process of claim 6 wherein the organic material is an adhesive polymer.

8. The process of claim 6 wherein the the laser is a nano-second pulse width laser.

9. The process of claim 1 wherein the protective coating layer is a first protective coating layer applied to the high cosmetic finish quality surface and comprises a metallic material.

10. The process of claim 9 wherein the laser is a micro-second pulse width laser.

11. The process of claim 9 wherein the metal part comprises a stainless steel and the first protective coating layer comprises at least one of a copper foil, an aluminum foil and a sheet of stainless steel.

12. The process of claim 9, further comprising:
applying a second protective coating layer to the opposing surface.

13. The process of claim 12 wherein the second protective coating layer comprises at least one of a clear adhesive tape and a transparent blue adhesive tape.

14. The process of claim 1 wherein the laser comprises at least one of a nano-second pulse width laser and a micro-second pulse width laser.

15. The process of claim 1 wherein the protective coating layer is a first protective coating layer applied to the opposing surface and a second protective coating applied to the high cosmetic finish quality surface, at least one of the first protective coating layer and the second protective coating layer comprising a metallic material.

16. In a process to laser micro-machine a stainless steel part with a high cosmetic quality surface and an opposing surface, the improvement comprising:
applying a first protective coating layer to a one of the high cosmetic quality surface and the opposing surface intended to be machined before micro-machining the part with a laser, the protective layer comprising a metallic material including at least one of aluminum, copper and stainless steel; and
micro-machining the one of the high cosmetic quality surface and the opposing machining surface with the laser, the laser including one of a nano-second pulse width laser and a micro-second pulse width laser.

17. The process of claim 16, further comprising:
applying a second protective coating layer to the other of the high cosmetic quality surface and the opposing surface before micro-machining the part with the laser.

18. The process of claim 17 wherein the second protective coating layer comprises one of the metallic material and an adhesive polymer.
